(19) United States
(12) Patent Application Publication
(10) Pub. No.: US 2001/0046855 A1
(43) Pub. Date: Nov. 29, 2001

(54) Method and apparatus for alarming on occurrence of cell secession of a mobile station in a mobile communication system

(76) Inventor: Tae-Young Kil, Seoul (KR)

Correspondence Address: Robert E. Bushnell, Suite 300, 1522 K Street, N.W., Washington, DC, 20005-1202, US

(21) Appl. No.: 09/801,807

(22) Filed: Mar. 9, 2001

(30) Foreign Application Priority Data
May 24, 2000 (KR) 2000-28079

(51) Int. Cl. H04Q 7/20

(52) U.S. Cl. 455/421; 455/67.7; 455/567

(57) ABSTRACT

A method and apparatus are provided for alarming upon occurrence of or expected occurrence of cell secession of a mobile station in a mobile communication system. A base station transceiver subsystem (BTS) receives power-related information transmitted from a mobile station, and analyzes the power-related information to determine whether a mobile station has seceded from a corresponding cell. The BTS transmits cell secession alarm information to a cell-seceded mobile station to enable the cell-seceded mobile station to perform a cell secession alarm operation to advise a subscriber of the cell-seceded mobile station of a possible call drop.

### PRIORITY

This application makes reference to, incorporates the same herein, and claims all benefits accruing under 35 U.S.C. § 119 from an application entitled “Method for Alarming Cell Secession in Mobile Station of Mobile Telecommunication System” earlier filed in the Korean Industrial Property Office on May 24, 2000 and there duly assigned Ser. No. 2000-28079.

### BACKGROUND OF THE INVENTION

1. Field of the Invention

The present invention relates generally to a radio mobile communication system, and in particular, to a method for generating, when a subscriber secedes from a base station transceiver subsystem (BTS), an alarm signal for informing a subscriber's terminal or a mobile station, of the secession.

2. Description of the Related Art

In a code division multiple access (CDMA) mobile communication system, a mobile station measures the strength of a signal transmitted from a BTS and displays received signal strength indication (RSSI) on a liquid crystal display (LCD) to enable the terminal user to observe the receiving sensitivity on the user's location. Further, the mobile station controls transmission power in inverse proportion to a level of the measured RSSI.

For example, the mobile station can display the level of the RSSI on the LCD using vertical rods, so that the subscriber can be visibly aware of the level of the RSSI at the sight of the rod indication. However, during a call, the user may have a difficulty in checking the rod indication representative of the level of the RSSI, so that the user may not be able address a situation where the level of the RSSI is lowered which can cause a decrease in the call sensitivity or a call drop, the call drop typically being undesirable the user.

U.S. Pat. No. 4,996,715 to Marui et al entitled Radio Telephone Apparatus disclose a radio telephone apparatus for use in a cellular mobile telephone system including means for alarming at least a user operating the apparatus in response to a drop in signal strength of radio frequency signals received over an established communication channel when the apparatus approaches a boundary of service area in a cellular mobile telephone system. The signal strength is repetitively checked to determine if it has fallen below a first predetermined signal strength value. When the signal strength falls to or below a second predetermined signal strength value, the radio telephone apparatus causes a disconnection of the telephone link and returns the apparatus to a standby mode.

U.S. Pat. No. 5,105,458 to Takenaka entitled Mobile Telephone System Having Message Recording Mode During Failures discloses a mobile telephone system, whereby a base station establishes a radio link to a mobile station and a connection to a switched telephone network when the mobile station is in communication with a network-side station. The base station monitors signals from the mobile station over the radio link. It the base station detects that the radio link is failing during a communication, an announcement is transmitted to the network-side station.

U.S. Pat. No. 5,134,708 to Marui et al. entitled Radio Telephone Apparatus disclose a radio telephone apparatus for use in a cellular mobile telephone system that includes an alarm to inform a user of a drop in signal strength of radio frequency signals received over an established communication link. Further, the mobile unit detects the presence or strength of a tone signal modulated on at least one of the received radio signals. The mobile unit disconnects the telephone link and returns to a standby mode if the tone signal is lost or becomes too weak.

U.S. Pat. No. 5,671,218 to I et al. entitled Controlling Power And Access Of Wireless Devices To Base Stations Which Use Code Division Multiple Access disclose that data signals to be transmitted from a plurality of wireless devices are spread across a common bandwidth. The data signals are received by a base station as a composite spread signal. The base station partially despreads the composite spread signal with unique codes to extract data signals from individual wireless devices. The data rate and quality of service requirements for each wireless device are used to calculate a power factor and a control signal is sent to control the power from a particular wireless device. In addition, a probability of transmission value is calculated based on an equivalent current load value and an equivalent population value. The probability of transmission value determines whether a particular wireless device is allowed access to an uplink frequency channel.

U.S. Pat. No. 5,684,790 to Hirasawa entitled Mobile Communication System discloses a mobile communication system that can preliminarily inform a user of the possibility of an occurrence of interruption of a call, which is peculiar to the system of the TDMA type. In this mobile communication system, a CPU measures a received level of speech quality by detecting data representing speech quality in an SACCH frame on the basis of a result of analysis of a received frame by means of a receiving portion. In the case where the received level is less than a predetermined value, a counting portion is caused to start counting. If the received level is low in the case of the next SACCH frame, the count is incremented. When the count reaches a predetermined value, a speaker serving as an alarming means is operated so as to produce a warning tone, so that a warning is given to a person who is currently using the system.

U.S. Pat. No. 5,799,244 to Matsumoto entitled Digital Mobile Unit Having A Function Of Issuing A Tone Level Controllable Input Signal Degradation Alarm And A Method Thereof discloses that in order to adaptively control a level of an alarm which warns of imminent or impending communication interruption, an error information signal and data frame energy, which are both derived during the decoding of an incoming signal, are used. If the incoming signal is deteriorated to an extent that communication interruption is imminent, an alarm signal is issued and superimposed on a voice signal. The level of the alarm signal is controlled in accordance with the detected frame energy.

U.S. Pat. No. 5,859,838 to Soliman entitled Load Monitoring And Management In A CDMA Wireless Communication System discloses a system and method for monitoring and managing the loading conditions in a CDMA wireless communication system. The system includes a load monitoring device, such as a CDMA mobile station, connected to a data logging and processing device, such as a diagnostic monitor. The monitoring device is placed within the service area of a base station. The monitoring device periodically initiates a call, is assigned to a traffic channel normally, and logs a power control parameter such as a mobile station transmit power or the number of closed-loop power control commands received per unit time. From this information, the load monitoring device can infer the real-time traffic loading conditions of the base station. If the loading of the system exceeds a predetermined threshold, an alarm may be sent to the system management center in order to take some action to limit additional loading on the base station.

### SUMMARY OF THE INVENTION

It is, therefore, an object of the present invention to provide a method for alarming on occurrence of cell secession when a subscriber's terminal secedes from a cell presently in service, by using the power control or handoff function to call to the subscriber's attention the occurrence of cell secession, in a mobile communication system.

To achieve the above and other objects of the present invention, there is provided a method for alarming on occurrence of cell secession of a mobile station in a mobile communication system. In the method, a base station transceiver subsystem (BTS) receives power-related information transmitted from each mobile station, and analyzes the power-related information to determine whether each mobile station has seceded from a corresponding cell. The BTS transmits cell secession alarm information to a cell-seceded mobile station to enable the cell-seceded mobile station to perform a cell secession alarm operation.

Preferably, to detect the occurrence of cell secession of the mobile station, the BTS determines whether a power level of the mobile station is less than or equal to a predetermined reference power level. Also, preferably, the BTS transmits a predetermined tone control message as the cell secession information when secession occurs over a forward traffic channel in the mobile communication system.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a network structure for explaining the concept of a private mobile communication service to which the present invention is applicable;

FIG. 2 is a flow chart illustrating a procedure for alarming on occurrence of cell secession of a mobile station in a mobile communication system according to an embodiment of the present invention; and

FIG. 3 is a diagram illustrating exemplary types of messages on a forward traffic channel in the mobile communication system to which the present invention is applied.

### DETAILED DESCRIPTION OF THE PREFERRED EMBODIMENTS

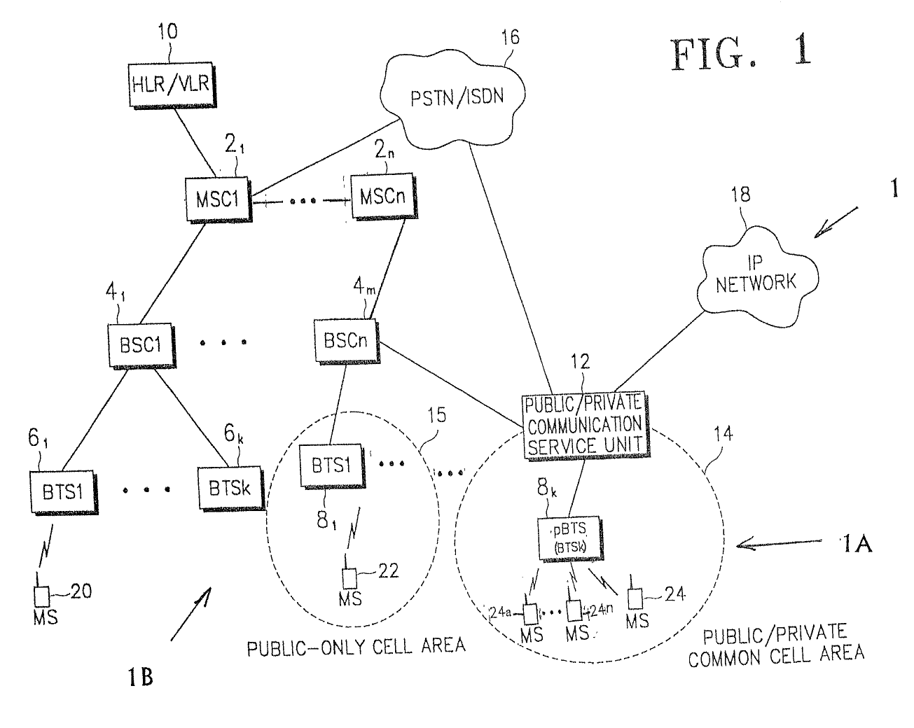

Preferred embodiments of the present invention will be described herein below with reference to the accompanying drawings of FIGS. 1 through 3.

The present invention is preferably applied to a private radio switching system. In general, a mobile communication system performs cell mapping so as to cover the entire region of a nation, for example. Therefore, when a mobile station located in a specific cell moves out of, or secedes from, the specific cell, a handoff occurs to a target cell to which the mobile station is moving. However, the private radio switching system is generally structured such that a call is dropped when a private mobile station moves out of the cell coverage. Therefore, it is preferable to apply the methods and apparatus of the present invention for alarming upon occurrence of cell secession of the mobile station in the private radio switching system.

FIG. 1 illustrates a network structure for explaining the concept of a private mobile communication system to which the present invention is applicable. Referring now to FIG. 1, FIG. 1 illustrates a public/private common radio communication system 1. Referring to FIG. 1, the public/private radio communication system 1 includes a public/private common cell 14, which is a public/private common communication service area, and a public/private communication service unit 12. Preferably, the public/private common cell 14 is set so as to provide a communication service to a specific group as a private mobile communication system 1A. For example, when a certain company or organization uses, or occupies, one building, the area belonging to the building can be defined as the public/private common cell 14.

Continuing with reference to FIG. 1, the public/private common cell 14 is preferably defined by mutual agreement with the public mobile communication service provider. In this regard, this is to have a private base station transceiver subsystem (BTS) 8ₖ in the public/private common cell 14 to be recognized as a private BTS (pBTS) from the viewpoint of a public mobile communication system 1B. In the following description, the private BTS 8ₖ will be referred to as “pBTS”, in order to distinguish the private BTS 8ₖ in the public/private common cell 14 from the base station transceiver subsystems (BTSs) belonging to the public mobile communication system 1B, namely, the BTSs 6₁-6ₖ (BTS1 to BTSk) to BTS 8₁ (BTS1) shown in FIG. 1, for example. The pBTS 8ₖ, together with a mobile station (MS) 24 in the public/private common cell 14, forms a radio communication path, to perform a function of managing radio resources, and is connected to a base station controller (BSC) 4ₘ (BSCn) of the public mobile communication system 1B through the public/private communication service unit 12. The public/private communication service unit 12 is connected to BSC 4ₘ (BSCn), public switched telephone network/integrated services digital network (PSTN/ISDN) 16, and internet protocol (IP) network 18.

Also, the public/private communication service unit 12 can optionally provide the public mobile communication service and the private mobile communication service to any of the mobile stations (MS) 24, 24a to 24n, such as to the MS 24, in the public/private common cell 14. Moreover, if a mobile station, such as the MS 24, is registered in the public/private communication service unit 12 to receive the private mobile communication service, the MS 24 can receive not only the public mobile communication service but also the private mobile communication service, as well. However, if a mobile station, such as the MS 24, is not registered in the public/private communication service unit 12, the MS 24 can receive only the public mobile communication service. In addition, the public/private communication service unit 12 can perform a wire communication service with the PSTN/ISDN 16 and the IP network 18.

Continuing with reference to FIG. 1, the public mobile communication network or system 1B is commonly part of a public land mobile network (PLMN). As illustrated in FIG. 1, the public land mobile communication network includes a plurality of mobile switching centers (MSCs) 2₁-2ₙ, (MSC1 to MSCn), a plurality of base station controllers (BSCs) 4₁-4ₘ (BSC1 to BSCn), a plurality of base station transceiver subsystems (BTSs) 6₁-6ₖ (BTS1 to BTSk) to 8₁-8ₖ (BTS1 to BTSk), a plurality of mobile stations (MSs) 20, 22 and 24, 24a to 24n and a home location register/visitor location register (HLR/VLR)10. Each of the MSCs 2₁-2ₙ (MSC1 to MSCn) is connected to its associated corresponding one of BSCs 4₁-4ₘ, (BSC1-BSCn) and each of the BSCs 4₁-4ₘ (BSC1-BSCn) is respectively connected to its associated corresponding BTSs 6₁-6ₖ (BTS1-BTSk) to 8₁-8ₖ (BTS1-BTSk). In particular, the pBTS 8ₖ is one of the BTSs 8₁-8ₖ (BTS1 to BTSk) connected to the BSC 4ₘ (BSCn) of the public mobile communication system 1B according to an embodiment of the present invention.

Continuing with reference to FIG. 1, the MSCs 2₁-2ₙ (MSC1- MSCn) each respectively control the connection between the BSCs 4₁-4ₘ (BSC1-BSCn) respectively connected thereto and the PSTN/ISDN 16 or another MSC in the public mobile communication network or system 1B. The BSCs 4₁-4ₘ (BSC1 to BSCn) each perform radio link control and handoff functions, and the BTSs 6₁-6ₖ (BTS1 to BTSk) to 8₁-8ₖ (BTS1 to BTSk) perform the functions of forming radio communication paths to the respective MSs 20, 22 and 24, 24a to 24n belonging to their communication service area, i.e., their cell area and managing the radio resources. In the HLR/VLR 10, the home location register (HLR) has a subscriber location registration function and a database function for storing subscriber information, and the visitor location register (VLR) has a database function for temporarily storing information about the MS existing in the cell managed by a corresponding one of the MSCs 2₁-2ₙ (MSC1-MSCn). If the MS moves to a cell managed by another MSC, the corresponding information stored in the VLR of the HCR/VCR 10 is deleted.

In the above described system, such as illustrated in FIG. 1, radio communication service typically will be provided free of charge between the mobile stations MS 24, 24a to 24n in the public/private common cell 14 of the pBTS 8ₖ which is the BTS registered in the public/private communication service unit 12, i.e., the mobile stations registered in the private radio network. Therefore, during a call between the mobile stations registered in the private network within the public/private common cell 14, if a corresponding mobile station secedes from the public/private common cell 14, the call will be dropped or the mobile station will use another BTS so that the subscriber typically would be charged for the call. In this case, it is preferable to apply the methods and apparatus for alarming upon occurrence cell secession of the mobile station according to the present invention.

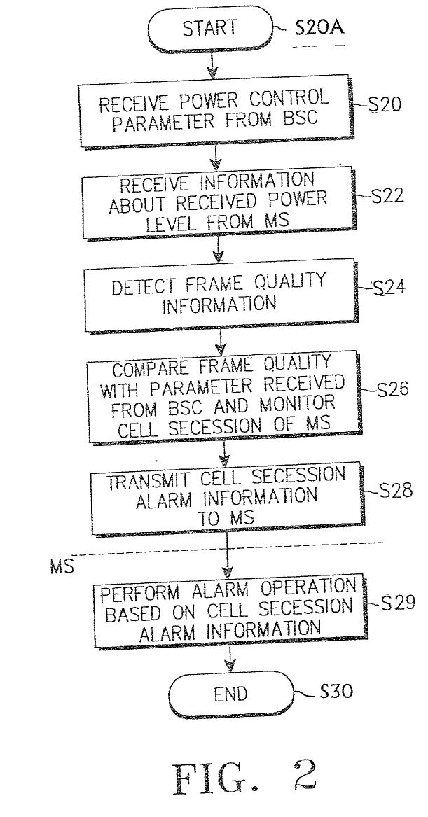

Continuing with reference to FIG. 2, a detailed description will be made of an operation according to the methods and apparatus of the present invention. FIG. 2 illustrates a procedure for alarming upon occurrence of cell secession of a mobile station in a mobile communication system according to the present invention. A CDMA system performs very accurate power control so that a signal from a mobile station should be received at a BTS at the least signal-to-noise ratio (SNR), in order to maximize the capacity. The present invention desirably utilizes this power control function.

Each mobile station transmits a radio frequency (RF) signal for a new channel assignment request, and the RF signal includes data indicating a power level detected by the mobile station. Each mobile station periodically samples the power level transmitted from a corresponding BTS and then transmits the sampled power level back to the BTS. The BTS then receives the sampled power level transmitted from each mobile station and analyzes a variation of the power level of the corresponding mobile station. Such an operation is performed for the power control and handoff of each mobile station. An operation according to the methods and apparatus of the present invention is performed by analyzing the information about the power level provided from the mobile station.

Referring now to FIG. 2, the process starts at step S20A, and a corresponding BTS receives a power control parameter of a mobile station from a corresponding BSC in step S20. Thereafter, in step S22, the corresponding BTS receives information about the received power level from the mobile station. The mobile station measures received power from the corresponding BTS and reports this information to the corresponding BTS through a “power measurement report message” or an “erasure indicator bit” which is inserted in every frame at a predetermined time. Accordingly, in step S22, the corresponding BTS receives information about the received power level from the corresponding mobile station, and then the corresponding BTS detects information about the frame quality from the received information in step S24. That is, upon receipt of the power measurement report message or the “erasure indicator bit”, the corresponding BTS determines, such as by calculating, a forward frame error rate (FER) from an “error detected” field corresponding to the “erasure indicator bit” and a “power measure frame” field included in the received power measurement report message.

Continuing with reference to FIG. 2, the process proceeds to step S26, and, in step S26, the corresponding BTS compares the frame quality with the power control parameter received from the corresponding BSC to monitor cell secession of the corresponding mobile station. That is, the mobile communication system compares the calculated, or determined, FER with a power control parameter value of the mobile communication system and predicts, or determines, a power level of the corresponding mobile station. When the power level of the corresponding mobile station decreases below a predetermined reference power level, the mobile communication system considers that the corresponding mobile station has seceded from the cell. Thus, in order to guarantee the reliability, the predetermined reference power level is set to a value which is slightly larger than a pilot power corresponding to the complete switching to the BTS, thereby to prevent generating alarm information due to erroneous information.

The process then proceeds to step S28 in FIG. 2 and, in step S28, cell secession alarm information is transmitted to the corresponding mobile station, when cell secession is expected or upon occurrence of cell secession. That is, when it is considered that the corresponding mobile station has seceded from the cell, the mobile communication system transmits an alarm signal on a forward traffic channel in the mobile communication system, such as to a vocoder through an air interface. The signal transmitted over the forward traffic channel is transmitted to the corresponding mobile station to inform the subscriber in service of the present status that the mobile station is seceding from the cell. This alarm information is transmitted to the mobile station by setting a “flash-with-information message” or an “alert-with-information message” on the forward traffic channel. Upon receipt of such message, the corresponding mobile station generates an alarm tone in step S29, and the process then proceeds to end at step S30. Accordingly, a subscriber at the corresponding mobile station can take a proper preliminary action.

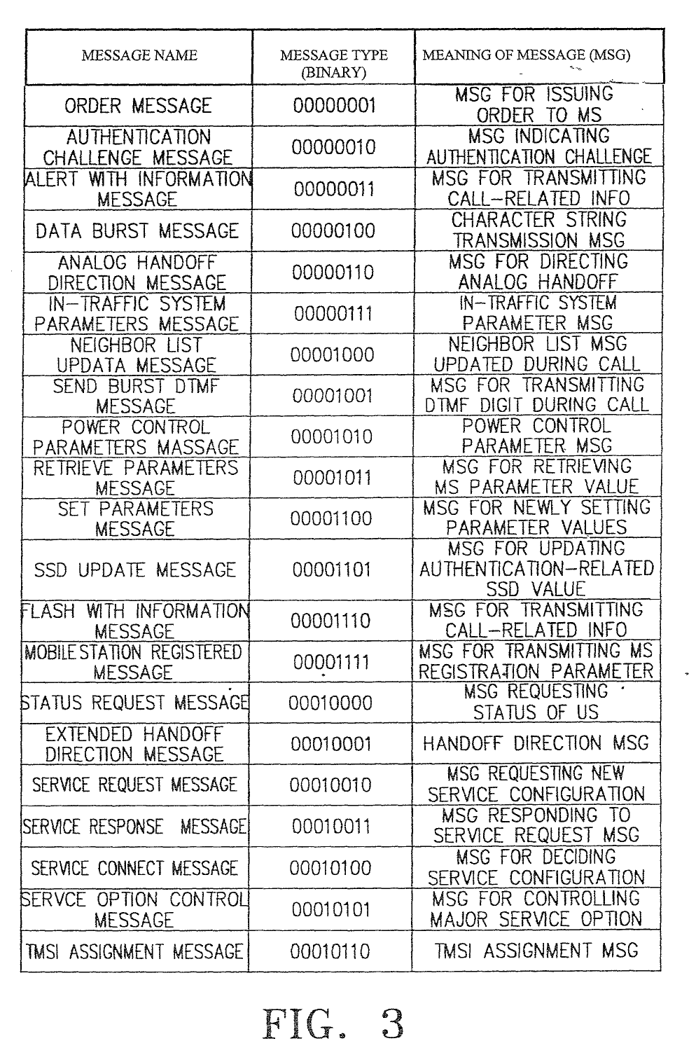

Referring now to FIG. 3, FIG. 3 illustrates exemplary types of messages on the forward traffic channel in the mobile communication system over which the cell secession alarm information is transmitted, such as in the case where the method and apparatus of the present invention are applied to an IS-95 mobile communication system, for example, IS-95 being a CDMA “Mobile Station-Base Station Compatibility Standard for Dual Mode Wideband Spread Spectrum Cellular System”. FIG. 3 illustrates various message names together with a corresponding message type and a corresponding meaning of a message (MSG) for a corresponding message in tabular form as can be implemented in the mobile communication system of FIG. 1, for example. In an embodiment of the present invention, for example, the alarm information is transmitted by setting a proper parameter to the “flash-with-information message” or the “alert-with-information message” on the forward traffic channel in the mobile communication system, as shown in FIG. 3.

Further, for example, when the process illustrated shown in FIG. 2 is applied to the private radio mobile communication system 1A of FIG. 1, for example, the corresponding BTS of the corresponding private radio mobile communication system 1A, such as PBTS 8ₖ first performs an operation of determining whether the corresponding mobile station, such as MS24, is registered to be able to use the private mobile communication service and whether an extension call is performed between registered subscribers, such as between registered mobile stations. When the call is an extension call between the registered subscribers, the cell secession alarm operation and process shown in FIG. 2 is performed. Otherwise, when the call is not an extension call between the registered subscribers, a handoff occurs to a neighbor BTS, such as BTS8₁, upon detection of occurrence or expected occurrence of the cell secession.

As described above, a radio mobile communication system of the present invention generates an alarm signal to the mobile station when the subscriber's terminal, or mobile station, secedes from the designated cell during a call. In this manner, it is possible to alarm upon occurrence of or expected occurrence of cell secession before the call is dropped, when the subscriber is moving out of the service area (i.e., a specific BTS or a specific cell), thereby preventing an abrupt call drop. Such a function is typically more effective when applied to an in-building communication service system rather than to a general CDMA system, although the present invention can be applied to a general CDMA system.

In addition, as described above, the present invention advantageously does not necessarily use a dual tone multi-frequency (DTMF) sender resource of a time switch when transmitting the alarm signal. In general, the system to which the present invention is applicable typically has limited DTMF resources. Therefore, when one mobile station continuously occupies the DTMF resource, typically other mobile stations cannot receive the DTMF service. Accordingly, the present invention receives a power-related message from the corresponding mobile station, analyzes the received message and transmits a tone control message over a forward traffic channel of the mobile communication system, thereby to advantageously save the common resources, such an DTMF resources, of the mobile communication system.

While the method and apparatus of the present invention has been shown and described with reference to a certain preferred embodiments, the methods and apparatus of the present invention should not be construed in a limiting sense. For example, although the present invention has been described with reference to an in-building private BTS, the methods and apparatus of the present invention can also be applied to a general CDMA system. That is, if the power level becomes too low to maintain the call and there is no neighbor BTS or no available channel, even though there is a neighbor BTS, the mobile communication system generates an alarm signal for the subscriber so that the subscriber may prepare for the call drop.

While there have been illustrated and described what are considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation to the teaching of the present invention without departing from the scope thereof. Therefore, it is intended that the present invention not be limited to the particular embodiments disclosed as the best mode contemplated for carrying out the present invention, but that the present invention includes all embodiments falling within the scope of the appended claims.

What is claimed is:

1. A method for alarming on occurrence of cell secession of a mobile station in a mobile communication system, comprising the steps of:
receiving in a base station transceiver subsystem in the mobile communication system power-related information transmitted from a corresponding mobile station in the mobile communication system;
analyzing the power-related information received to determine whether the corresponding mobile station has seceded from a corresponding cell in the mobile communication system; and
transmitting cell secession alarm information to the corresponding mobile station when it is determined from the analyzed power-related information that the corresponding mobile station has seceded from the corresponding cell to enable the corresponding mobile station to perform a cell secession alarm operation.

2. The method as claimed in claim 1, further comprised of the analyzing the power-related information step comprises the step of determining whether a power level of the corresponding mobile station is less than a predetermined reference power level, a power level less than the predetermined reference power level indicating the corresponding mobile station has seceded from the corresponding cell in the mobile communication system.

3. The method as claimed in claim 2, further comprised of the step of transmitting cell secession alarm information comprises the step of transmitting a predetermined tone control message over a forward traffic channel in the mobile communication system indicating the corresponding mobile station has seceded from the corresponding cell in the mobile communication system.

4. The method as claimed in claim 3, further comprised of the cell secession alarm operation advising a user of the corresponding mobile station of a possible call drop.

5. The method as claimed in claim 1, further comprised of the step of transmitting cell secession alarm information comprises the step of transmitting a predetermined tone control message over a forward traffic channel in the mobile communication system indicating the corresponding mobile station has seceded from the corresponding cell in the mobile communication system.

6. The method as claimed in claim 1, further comprised of the cell secession alarm operation advising a user of the corresponding mobile station of a possible call drop.

7. A method for alarming on occurrence of cell secession of a mobile station in a private radio mobile communication system, comprising the steps of:
receiving power-related information transmitted from a corresponding mobile station in a corresponding cell in the private radio mobile communication system;
analyzing the power-related information received to determine whether the corresponding mobile station has seceded from the corresponding cell in the private radio mobile communication system; and
transmitting predetermined cell secession alarm information to the corresponding mobile station, when it is determined from the analyzed power-related information that the corresponding mobile station has seceded from the corresponding cell and when the corresponding mobile station is registered to use a private radio communication service and is having an extension call with another registered mobile station, so as to enable the corresponding mobile station to perform a cell secession alarm operation.

8. The method as claimed in claim 7, further comprised of the step analyzing the power-related information comprises the step of determining whether a power level of the corresponding mobile station is less than a predetermined reference power level, a power level less than the predetermined reference power level indicating the corresponding mobile station has seceded from the corresponding cell in the private radio mobile communication system.

9. The method as claimed in claim 8, further comprised of the step of transmitting predetermined cell secession alarm information comprises the step of transmitting a predetermined tone control message over a forward traffic channel in the private radio mobile communication system indicating the corresponding mobile station has seceded from the corresponding cell in the private radio mobile communication system.

10. The method as claimed in claim 9, further comprised of the cell secession alarm operation advising a user of the corresponding mobile station of a possible call drop.

11. The method as claimed in claim 7, further comprised of the step of transmitting predetermined cell secession alarm information comprises the step of transmitting a predetermined tone control message over a forward traffic channel in the private radio mobile communication system indicating the corresponding mobile station has seceded from the corresponding cell in the private radio mobile communication system.

12. The method as claimed in claim 7, further comprised of the cell secession alarm operation advising a user of the corresponding mobile station of a possible call drop.

13. A method for alarming on occurrence of cell secession of a mobile station in a mobile communication system, comprising the steps of:
receiving in a base station transceiver subsystem in the mobile communication system a power control parameter of a corresponding mobile station in the mobile communication system from a corresponding base station controller in the mobile communication system;
receiving by the base station transceiver subsystem information as to a received power level from the corresponding mobile station, the received power level being determined by the corresponding mobile station measuring received power from the base station transceiver subsystem;
detecting by the base station transceiver subsystem information as to a frame quality by determining a forward frame error rate from the received information as to the received power level from the corresponding mobile station;
comparing the determined forward frame error rate with a value corresponding to the power control parameter received from the corresponding base station controller to provide a determined power level of the corresponding mobile station;
determining when the determined power level of the corresponding mobile station decreases below a predetermined reference power level, a determined power level less than the predetermined reference power level indicating the corresponding mobile station has seceded from a corresponding cell in the mobile communication system; and
transmitting cell secession alarm information to the corresponding mobile station when the determined power level is less than the predetermined reference power level indicating the corresponding mobile station has seceded from the corresponding cell in the mobile communication system.

14. The method as claimed in claim 13, further comprised of the information as to the received power level from the corresponding mobile station including at least one of a power measurement report message as to the received power level from the corresponding mobile station and an erasure indicator bit as to an error detected field.

15. The method as claimed in claim 14, further comprised of the cell secession alarm operation advising a user of the corresponding mobile station of a possible call drop.

16. The method as claimed in claim 13, further comprised of the cell secession alarm operation advising a user of the corresponding mobile station of a possible call drop.

17. An apparatus for alarming on occurrence of cell secession of a mobile station in a mobile communication system, comprising:
a base station transceiver subsystem in the mobile communication system for receiving power-related information transmitted from a corresponding mobile station in the mobile communication system;
means for analyzing the power-related information received to determine whether the corresponding mobile station has seceded from a corresponding cell in the mobile communication system; and
means for transmitting cell secession alarm information to the corresponding mobile station when the means for analyzing determines that the corresponding mobile station has seceded from the corresponding cell to enable the corresponding mobile station to perform a cell secession alarm operation.

18. The apparatus as claimed in claim 17, further comprised of the means for analyzing the power-related information comprising means for determining whether a power level of the corresponding mobile station is less than a predetermined reference power level, a power level less than the predetermined power level indicating the corresponding mobile station has seceded from the corresponding cell in the mobile communication system.

19. The apparatus as claimed in claim 18, further comprised of the means for transmitting cell secession alarm information comprising means for transmitting a predetermined tone control message over a forward traffic channel in the mobile communication system indicating the corresponding mobile station has seceded from the corresponding cell in the mobile communication system

20. The apparatus as claimed in claim 19, further comprised of the cell secession alarm operation advising a user of the corresponding mobile station of a possible call drop.

21. The apparatus as claimed in claim 19, further comprised of the mobile communication system being a private radio mobile communication system.

22. The apparatus as claimed in claim 17, further comprised of the means for transmitting cell secession alarm information comprising means for transmitting a predetermined tone control message over a forward traffic channel in the mobile communication system indicating the corresponding mobile station has seceded from the corresponding cell in the mobile communication system.

23. The apparatus as claimed in claim 17, further comprised of the cell secession alarm operation advising a user of the corresponding mobile station of a possible call drop.

24. The apparatus as claimed in claim 17, further comprised of the mobile communication system being a private radio mobile communication system.
